(19) United States
(12) Patent Application Publication
(10) Pub. No.: US 2024/0043093 A1
(43) Pub. Date: Feb. 8, 2024

(54) WATERCRAFT

(71) Applicant: Mäkeniq UG, Freiberg (DE)

(72) Inventor: Felix BÖRNER, Freiberg (DE)

(73) Assignee: Mäkeniq UG, Freiberg (DE)

(21) Appl. No.: 18/265,202

(22) PCT Filed: Dec. 6, 2021
(86) PCT No.: PCT/IB2021/061105

§ 371 Date: Jun. 2, 2023

(30) Foreign Application Priority Data
Dec. 4, 2020 (CH) 01536/20
Nov. 10, 2021 (CH) 070534/2021

(51) Int. Cl. B63B 1/10; B63B 1/12; B63B 1/28

(52) U.S. Cl. CPC B63B 1/107; B63B 1/121; B63B 1/28

(57) ABSTRACT

A watercraft, in particular a SWATH-type yacht is intended to have improved and greater functional properties. To this end, the watercraft, in particular a SWATH-type yacht, has upper works that receive a structure, and on the underside thereof, i.e. the wet deck, two stilts, i.e. partial hulls are arranged which are spaced apart from one another transversely in the direction of travel. Each partial hull is positioned on a submerged hull which is arranged substantially in the direction of travel of the watercraft and extends over at least part of the upper works. The submerged hulls have characteristic narrowed portions in cross section, which portions are formed on the longitudinal extension of swimmer profiles of the partial hull.

### FIELD OF THE INVENTION

The invention pertains to a watercraft, particularly a SWATH-type yacht.

The invention furthermore pertains to a method/device for controlling the operation of such a watercraft.

### BACKGROUND

Ships with double hulls (catamarans) are known, as are watercraft with a hull realized in accordance with the SWATH (Small Waterplane Area Twin Hull) design, which results in a reduced waterplane area and a greater immersion depth of the watercraft. SWATH-type ships have a greater immersion depth than catamarans. This design allows reduced movements of the ship in a seaway. For example, DE 202004017969 U1 discloses a pilot or service vessel, in which the buoyancy bodies arranged on supports on the hull bottom can be partially flooded. In this way, the floating position of the vessel and therefore also its draught can be essentially kept constant. A similar watercraft is described in DE 202013010071 U1.

In a SWATH-type ship according to DE 202009011206 U1, at least a section of a buoyancy body should be exchangeable in order to ensure easy access to relevant components in the buoyancy bodies, e.g. the propulsion system of the ship.

DE 202010015531 U1 furthermore discloses a watercraft with lateral outriggers and only one buoyancy body that extends over at least a portion of the hull body in the direction of travel and is arranged in the hull center parallel to the lateral outriggers. The connection between the hull bottom and the buoyancy body is once again produced by means of a support arrangement.

With respect to high-quality yachts, in particular, the shipbuilding industry offers no applicable solutions for supporting the conversion from conventional propulsion systems that operate with fossil fuels to propulsion systems that can be operated with renewable energies. Conventional yachts in lightweight construction usually suffer from a lack of seaworthiness, the construction quality or the energy balance for being a premium product and conventional yachts in traditional construction usually are excessively heavy and not sufficiently efficient for being operated in an autarkic manner.

### SUMMARY OF THE INVENTION

One aspect of the invention relates to a watercraft, particularly a SWATH-type yacht, which has improved and greater functional properties in comparison with the prior art and, in particular, also allows private, noncommercial use.

The inventive watercraft, which in the present example is a yacht 1 of the premium segment, has a SWATH-type design comprising upper works that receive a structure, wherein two partial hulls (stilts), which are spaced apart from one another transverse to the direction of travel, are arranged on the underside of said upper works, i.e. the wet deck. These partial hulls essentially extend in the direction of travel of the watercraft over at least a portion of the upper works. The partial hulls are respectively seated on a submerged hull, i.e. a buoyancy body, which essentially is arranged in the direction of travel of the watercraft and extends over at least a portion of the upper works. The submerged hulls have characteristic narrowed portions that are formed so as to be optimized for the longitudinal extent of the float profiles of the partial hulls and correspond to this longitudinal extent with a minimal offset.

While traveling, a harmonizing system of standing waves above and below the water surface, which originate from the submerged hulls and the bow and stem of each individual float of the partial hulls, reduces the drag significantly because these standing waves neutralize and cancel out one another due to the geometric design and positioning of the partial hulls (stilts).

The inventor has recognized that the wave-forming drag of SWATHs has the greatest influence on the overall drag whereas the frictional portion turns out to be rather low. Added to this are interference patterns between two partial hulls, which are caused by the superposition of the created surface waves, wherein the “peaks and valleys” of said interference patterns can lead to unfavorable flows against the propeller, which in turn would lower the propulsion efficiency and also deflect the ship from its actual alignment while traveling. The energy consumption while traveling can increase enormously if the ship deviates from the construction water line CWL with respect to its alignment and position. Metaphorically speaking, the ship constantly attempts to ride up on its own bow wave while it is assumed that the entire available energy is used for traveling straight.

It is therefore advantageous to reduce the surface waves and interference patterns caused by the wave-forming drag as much as possible and to keep the ship “straight on line” while traveling. As a result, the inventive watercraft travels up to 2-times more efficiently than comparable yachts. Consequently, it only requires half the energy for traveling with the same speed.

The interferences are dependent on the center distance of the partial hulls from one another whereas the partial hull with the complementary waves on float and submerged hull is not dependent on this center distance such that the functional principle already applies to a single partial hull. This is the reason why this arrangement can also be used for watercraft with three (or more) partial hulls or only one partial hull with two lateral outriggers (SWASH).

The inventive hull shape is highly optimized for SWATH-type watercraft.

Preferred and advantageous embodiments of the invention are disclosed in the dependent claims.

In order to introduce the effects of pressures and vibrations, the point of each submerged hull is designed in the form of a bulge and arranged at a distance from the bow float of the partial hull.

The floats (or their displacement extents) are offset between both partial hulls along the longitudinal axis, namely shifted rearward relative to the submerged hulls. In this way, the waves of both floats of the partial hulls can be almost completely eliminated due to the flow behavior of the submerged hulls.

The fins and transverse thrusters are positioned with analog offset such that they promote this effect with the waves originating therefrom. This corresponding system is not limited to the bow float only, but also develops the same effect in similar form on the stem float.

The waves being created are not always completely eliminated and a small remaining portion still manages to propagate on the surface. A corresponding arrangement of the floats makes it possible to influence and shift the interference patterns being created into more favorable areas. The propeller efficiency at certain speeds ideally can be additionally increased by utilizing this effect.

The watercraft basically has to be aligned exactly straight in accordance with the construction water line CWL. Numerous influences, e.g. waves, storm, uneven weight transfer, extreme turns, etc., counteract this alignment, which is the reason why a proactive stabilization system (PSS) is used for keeping the ship on the construction water line CWL in any situation. Other constructive stabilization and alignment measures, e.g. gyroscopes, stabilizing fins or additional ballast tanks, are likewise possible.

Transverse thrusters and fins are optionally and advantageously provided on both submerged hulls.

According to the invention, the ratio of the offset or the extent of the displacement (float) to the submerged hull curvature can be formulated as follows:

$${p}_{A} = \frac{{A}_{{T}_{1}} - {A}_{{T}_{2}}}{\sqrt{{A}_{{S}_{2}}} \cdot {Δ}_{T}} \\ {p}_{V} = \frac{{Δ}_{L}}{{S}_{1} - {S}_{2}}$$

In this case, A_{T1} and A_{T2} represent the cross-sectional area at the locally thickest point (T₁) and the locally thinnest point (T₂) of the submerged hull and A_{S2} represents the cross-sectional area underneath the CWL 20 at the thickest point S₂ of the float.

Furthermore,
p_{A} identifies the curvature progression factor and
p_{V} identifies the length offset factor,
i.e. similarity factors.

The distance between T₁ and T₂ is Δ_{T}. Furthermore, S₁ is the position of the point of the float. Consequently, the offset Δ_{L} of the float point S₁ relative to the thickest point of the submerged hull T₁ is defined as

Δ_{L}=T₁−S₁

This results in a pattern of the partial hulls (submerged hulls, floats) with a characteristic shape and defined proportions, wherein the dimensions and relations with respect to a cited value range apply equally to bow floats, as well as stern floats:

p_{A}≈0,12 . . . 0,23

p_{V}≈0,17 . . . 0,25

The use of the most modern and deeply integrated software technology for managing and operating yachts is not customary in the relevant industry.

The advantages of the inventive watercraft can be seen in an autarkic, fully electric yacht that preferably is operated with solar energy and allows noiseless cruising and roll-free traveling with unlimited range.

In addition, the structure has a planking with variable surface area, which is essentially or at least predominantly covered with photovoltaic elements.

Other advantages are the absence of diesel and exhaust odors, a highly efficient and optimized hull, traveling performances that are comparable to conventional motor yachts available on the market, innovative lightweight construction, luxurious living comfort without compromises, unique exterior and interior design tailored to the technology and the use of modern software such as machine learning for managing and optimizing the entire yacht operation from energy management, navigation, automatic maneuvering and controlling all components to maintenance analysis and problem support.

### BRIEF DESCRIPTION OF THE DRAWINGS

An exemplary embodiment of the invention is described in greater detail below with reference to the drawings. In these drawings,

FIG. 1 shows a side view of a floating watercraft according to the invention;

FIG. 2 shows a hull body of the watercraft according to FIG. 1;

FIG. 3 shows a different view of a hull body according to FIG. 2;

FIG. 4 shows a different view of the inventive watercraft;

FIG. 5 shows a front view of a hull body;

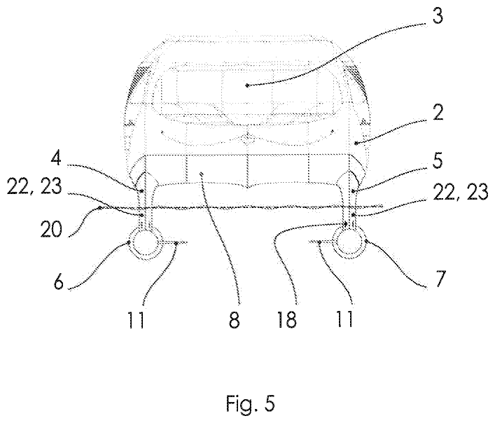

FIG. 6 shows an illustration of an interference viewed from above;

FIG. 7 shows an illustration of a length offset, and

FIG. 8 shows detailed illustration of a partial hull viewed from above.

### DETAILED DESCRIPTION

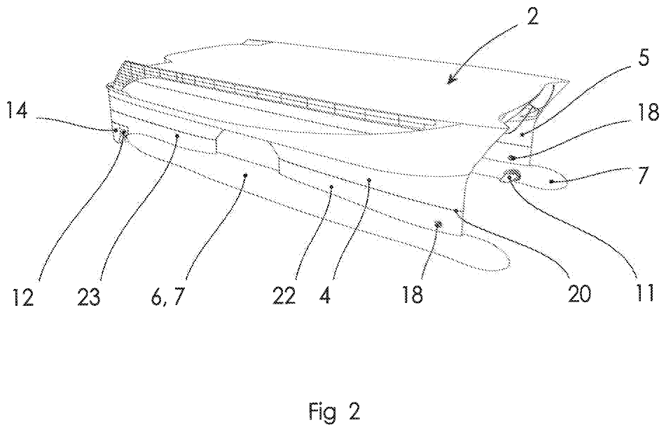

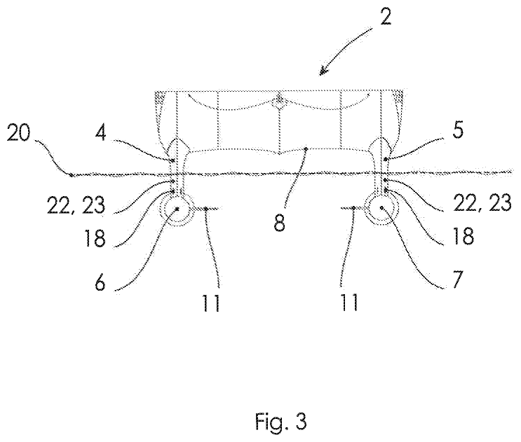

The inventive watercraft, which in the present example is a yacht 1 of the premium segment, has a SWATH-type design. It comprises upper works 2 that receive a structure 3, wherein two partial hulls 4, 5 (stilts), which are spaced apart from one another transverse to the direction of travel, are arranged on the underside of said upper works, i.e. the wet deck 8, and essentially extend in the direction of travel of the watercraft over at least a portion of the upper works 2, namely over the length thereof in the example shown (FIGS. 2, 3). The partial hulls 4, 5 are respectively seated on a submerged hull 6, 7 that essentially is arranged in the direction of travel of the watercraft and extends over at least a portion of the upper works 2 (namely also over the length thereof in the example shown). The submerged hulls 6, 7 and to some extent also the partial hulls 4, 5 are located below the construction water line 20 while traveling, i.e. in the operating state of the yacht 1.

The submerged hulls 6, 7 are provided with movable and controllable fins 11 (elevators), which in the idle position are directed toward one another (FIG. 3), in the bow region and the stem region of the yacht 1. The submerged hulls 6, 7 are equipped with an electric drive that has a rotor, the rotating direction of which is reversible, wherein said electric drive is provided with a propeller 12 and a rudder 14 on the stem side. Furthermore, a transverse thruster 18 is respectively located in the front floats 22, 23 in order to generate transversal thrust.

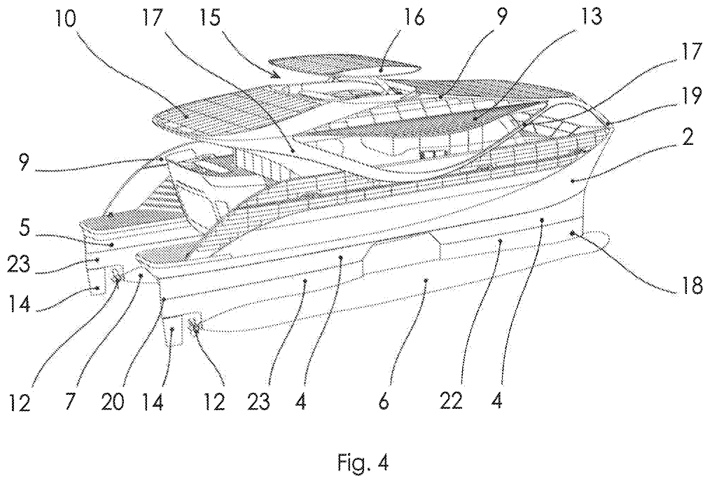

The upper works 2 are equipped with not-shown cabins and utility rooms for tenders, storage batteries, control devices, water and food supplies, etc. In the present example, the structure 3 has a living and lounge deck with a swim platform and an upper deck 15. The latter is likewise equipped with seating and reclining surfaces and also includes the workstation of the helmsman. The upper deck 15 is furthermore equipped with a roof 16 that can be raised (FIG. 4).

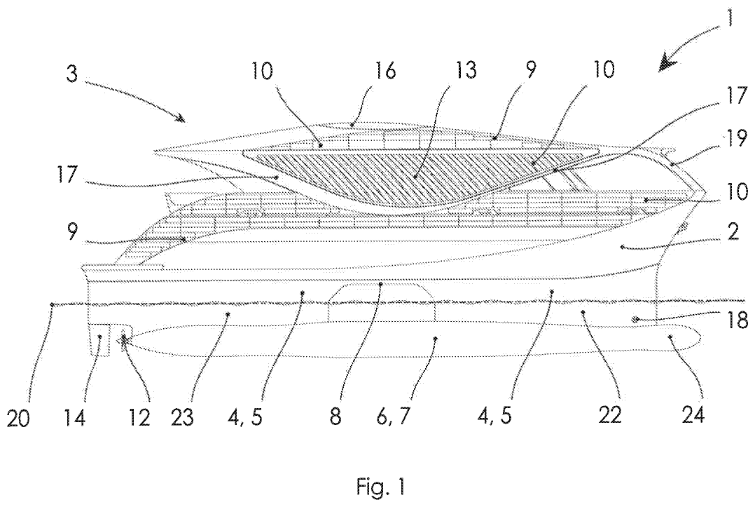

The structure 3 has a planking 9 with variable surface area, which is essentially covered with photovoltaic elements 10 (FIG. 1). The planking 9 furthermore is arranged in an at least partially foldable manner. In the present example, this is realized in that lateral parts 13 of the structure 3 have a curved, wing-like shape and can be respectively folded or pivoted as far as a nearly horizontal position in a wing-like manner (FIG. 4).

In this way, the usable surface area of the photovoltaic elements 10 is on the one hand enlarged in accordance with the position of the sun or the energy demand and cooling of the decks and cabins is on the other hand improved. A frame-like element, i.e. the structure 17, remains in the same position when the lateral parts 13 are folded out in order to statically support the roof structure 16 with the upper deck 15 together with the front support 19. A lightweight, integral configuration is thereby achieved for the entire structure.

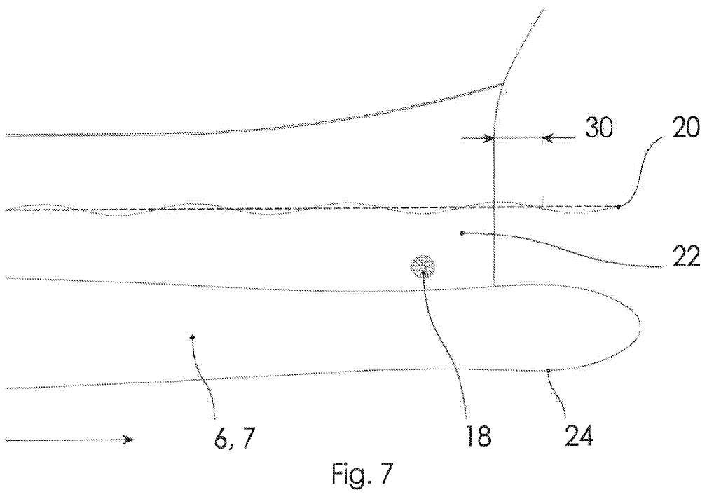

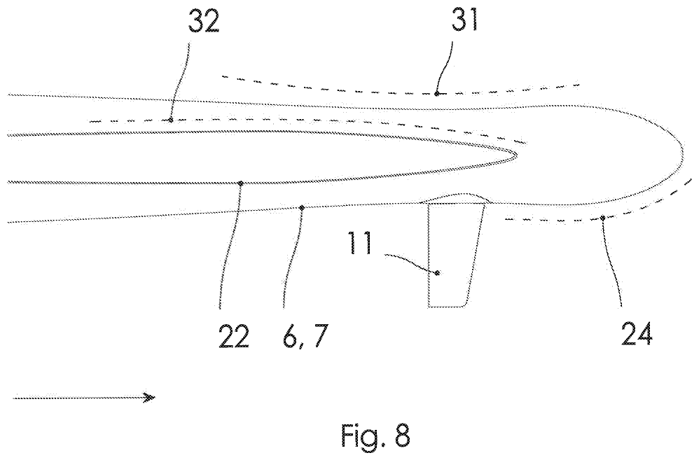

The submerged hulls 6, 7 have characteristic narrowed portions behind their point 24, wherein said narrowed portions are formed so as to be optimized in accordance with the extent of the float profiles 32 of the partial hulls 4, 5 and correspond to one another with a minimal offset 30, in the present example approximately 500 mm (FIGS. 7, 8).

This offset 30 of the “float displacement” between the two partial hulls 4, 5 is formed along the longitudinal axis, namely shifted rearward relative to the submerged hulls 6, 7. In this way, the waves of the two floats 22, 23 of the partial hulls 4, 5 can be eliminated or at least significantly reduced due to the flow behavior of the submerged hulls 6, 7.

The fins 11 and the transverse thrusters 18 are positioned with similar offset such that they additionally promote this effect with the waves originating therefrom. This corresponding system is not limited to the bow float 22 only, but also develops the same effect in similar form on the stem float 23.

Transverse thrusters 18 and fins 11 are advantageously arranged on both submerged hulls 6, 7.

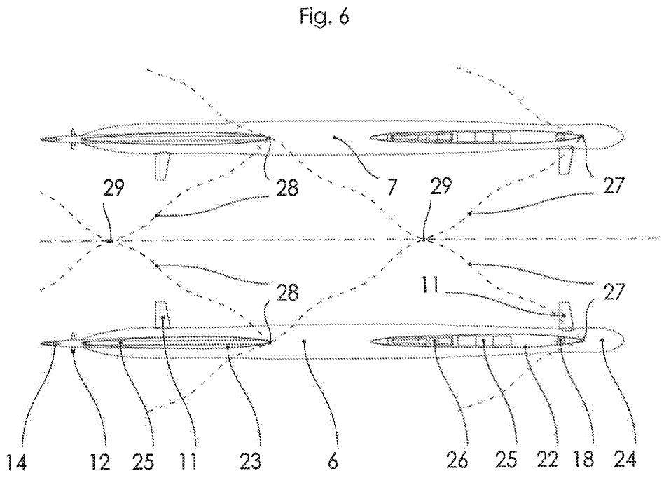

While traveling, a harmonizing system of standing waves above and below the water surface, which originate from the submerged hulls 6, 7 and the bow and stem of each individual float 22, 23 of the partial hulls 4, 5, reduces the drag significantly because these standing waves neutralize and cancel out one another due to the geometric design and positioning of the partial hulls 4, 5 (FIG. 6).

The waves being created are not always completely eliminated and a small portion can still propagate on the surface. A corresponding arrangement of the floats 22, 23 makes it possible to influence and shift the interference patterns being created into more favorable areas. The propeller efficiency at certain speeds can be additionally increased by utilizing this effect.

To this end, the watercraft, in the present example the yacht 1, has to be aligned exactly straight in accordance with the construction water line CWL 20. Numerous influences, e.g. waves, storm, uneven weight transfer, extreme turns, etc., counteract this alignment, which is the reason why a proactive stabilization system (PSS) is used for keeping the yacht 1 on the construction water line CWL 20 in any situation. Other constructive stabilization and alignment measures, e.g. gyroscopes, stabilizing fins 11 or ballast tanks 26, are likewise possible.

The yacht 1 may furthermore be provided with fuel cells, a generator or machine 25, hydrogen tanks and ballast tanks 26 in the submerged hulls 6, 7 (FIG. 6).

The storage batteries can also be charged in a harbor. Furthermore, hydrogen tanks can be refilled in a harbor or hydrogen can be generated with an onboard hydrogen generator by using shore power.

With respect to its dimensions, the yacht 1 according to the present example has a floor space of approximately 330 m² and can accommodate up to 12 guests.

The control of the yacht 1 is designed in such a way that it can be operated by a professional helmsman, as well as by guests as long as they have the corresponding nautical training and the required licenses. The control unit has components for propulsion and stability, navigation and communication, energy management, service management, safety and administration, wherein at least partially adaptive algorithms are used in the software for said components.

Conventional navigation means including satellite navigation are provided.

Wind forces, waves and currents can be respectively determined or calculated in real time while traveling.

The use of multiple LIDAR sensors also makes it possible to generate a 360° 3D image around the yacht 1. This allows constant monitoring all around the yard 1 and significantly simplifies docking and undocking maneuvers (comparably to a parking assistant in modern motor vehicles). The data of the LIDAR furthermore is used in the AMS for automatically maneuvering the yacht and for collision avoidance.

The inventive yacht also has a mechanism that is referred to as a proactive stabilization system (PSS) and serves for determining wave amplitudes in order to respectively evaluate or compare stability information of the hull based on the measured wash of the waves and to determine the amplitudes of approaching waves by means of a sensor.

This in turn makes it possible to determine expected washes of the waves against the hull and, if applicable, to carry out preventive course corrections or the like in order to reduce the stress on the ship and the crew and to simultaneously increase the efficiency of travel.

The disclosed yacht 1 only has few unpleasant roll and pitch movements, provides better safety in extreme situations, allows a lifestyle like on a superyacht at significantly lower costs for upkeep/use, lacks annoying engine noise, allows traveling speeds of 7-9 knots during multi-day trips, provides superior control of the yacht in stress situations, during maneuvering in narrow harbors, in waves and wind, allows monitoring of the ship environment and provides more redundancy for important system components.

### LIST OF REFERENCE SYMBOLS

1 Yacht
2 Upper works/hull body
3 Structure
4 Partial hull/stilt
5 Partial hull/stilt
6 Submerged hull
7 Submerged hull
8 Wet deck/underside
9 Planking
10 Photovoltaic element
11 Fin
12 Propeller
13 Lateral part
14 Rudder
15 Upper deck
16 Roof
17 Lateral support element
18 Transverse thruster
19 Front support
20 Construction water line CWL
21 —
22 Bow float
23 Stem float
24 Point of submerged hull
25 Propulsion engine
26 Ballast tanks
27 Bow wave of front float
28 Bow wave of rear float
29 Interference pattern
30 Length offset
31 Narrowed portion
32 Extent of float profile

1-11. (canceled)

12. A watercraft comprising upper works that receive a structure, wherein two partial hulls, which are spaced apart from one another transverse to a direction of travel, are arranged on an underside of the upper works, i.e. the wet deck, and essentially extend in the direction of travel of the watercraft over at least a portion of the upper works, and wherein the partial hulls are respectively seated on a buoyancy body, which includes a float and a submerged hull, essentially is arranged in the direction of travel of the watercraft and extends over at least a portion of the upper works, wherein the submerged hulls have characteristic narrowed portions in cross section, which are formed on the longitudinal extent of float profiles of the partial hull.

13. The watercraft according to claim 12, wherein the characteristic narrowed portions of the submerged hulls are arranged offset to the floats in the longitudinal direction.

14. The watercraft according to claim 12, wherein submerged hulls and floats are designed or can be represented with a ratio of the length offset with values for the length offset factor p_{V}≈0.17 . . . 0.25 or the extent of the displacement to the narrowed portion in cross section of the submerged hulls, i.e. the submerged hull curvature, with values for the curvature progression factor p_{A}≈0.12 . . . 0.23.

15. The watercraft according to claim 12, wherein the point of each submerged hull is designed in the form of a bulge and arranged at a distance from the bow float of the partial hull.

16. The watercraft according to claim 13, wherein fins and transverse thrusters are positioned with similar offset as the submerged hulls.

17. The watercraft according to claim 12, wherein transverse thrusters and fins are arranged on both submerged hulls.

18. The watercraft according to claim 12, wherein the structure has a planking with variable surface area, which is essentially covered with photovoltaic elements.

19. The watercraft according to claim 12, wherein the planking is arranged in an at least partially foldable or pivotable manner.

20. The watercraft according to claim 12, wherein at least one movable fin is arranged on the submerged hulls.

21. The watercraft according to claim 12, wherein the watercraft includes a control and a stabilization system, the software of which contains KI.

22. A watercraft comprising upper works that receive a structure, wherein two partial hulls, which are spaced apart from one another transverse to the direction of travel, are arranged on the underside of said upper works, i.e. the wet deck, and essentially extend in the direction of travel of the watercraft over at least a portion of the upper works, and wherein the partial hulls are respectively seated on a buoyancy body, which includes a float and a submerged hull, essentially is arranged in the direction of travel of the watercraft and extends over at least a portion of the upper works, wherein the structure has a planking with variable surface area, which is essentially covered with photovoltaic elements.
